(19) United States
(12) Patent Application Publication
(10) Pub. No.: US 2009/0189929 A1
(43) Pub. Date: Jul. 30, 2009

(54) CONTINUOUS PAPER WEB DUPLEX INKJET PRINTING UNIT

(75) Inventors: Kazuyuki MOTOJIMA, Kawasaki-shi (JP); Taizou ABE, Kawasaki-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOKYO KIKAI SEISAKUSHO, Tokyo (JP)

(21) Appl. No.: 12/255,807

(22) Filed: Oct. 22, 2008

(30) Foreign Application Priority Data
Jan. 25, 2008 (JP) 2008-14405

(51) Int. Cl. B41J 3/42

(52) U.S. Cl. 347/2

(57) ABSTRACT

It is sought to reduce the planar area on which a continuous paper web duplex inkjet printing unit is installed. To this end, a continuous paper web duplex inkjet printing unit for inkjet printing on both sides of a continuous paper web with an inkjet printing head in an inkjet printer is configured to comprise a plurality of inkjet printers 11a-11h disposed so that they lie vertically in steps and their inkjet printing heads face downwards, and a paper threading path 15 disposed below such an inkjet printer or printers in each steps for permitting the continuous paper web to be passed zigzag from an upper to a lower step successively.

### TECHNICAL FIELD

The present invention relates to a duplex printing unit with ink jet printers and in particular to a continuous paper web duplex inkjet printing unit for multicolored printing on both sides of a continuous paper web.

### BACKGROUND ART

On continuous paper web duplex inkjet printing units with inkjet printers, techniques have been known as described in, e. g., JP H11-320923 A, JP 2001-58446 A and JP 2003-11452 A.

The continuous paper web duplex inkjet printing units with inkjet printers described in JP H11-320923 A and JP 2001-58446 A above have inkjet printers with inkjet printing heads arranged to form an inkjet train widthwise of a continuous-paper web.

To wit, a continuous paper web duplex inkjet printing unit is so configured that inkjet printers of the same number as inks used to print a continuous paper web on its one side surface are arranged regularly spaced lengthwise of the continuous paper web, followed by inkjet printers of the same number as inks used to print the continuous paper web on its other side surface being arranged regularly spaced lengthwise of the continuous paper web. And, the continuous paper web guided below the inkjet printers to print on the one side surface is guided above the inkjet printers to print on the other side surface and is led to a continuous paper web reversal traveling mechanism such that when past the inkjet printers to print on the other side surface, the continuous paper web is reversed in guidance direction and that the continuous paper web turned over in paper side by this reversal is guided below the inkjet printers to print on the other side surface.

Consequently, the continuous paper web is guided below the inkjet printers to print on the one side surface, thereby printing on the one side surface, and then in the state that it is reversed and turned over by the continuous paper web reversal traveling mechanism is guided below the inkjet printers to print on the other side surface, thereby printing on the other side surface, and then on another reversal in direction of travel, is guided into the outside of the continuous paper web duplex inkjet printing unit.

The continuous paper web duplex inkjet printing unit described in JP 2003-11452 A is structurally provided with a turnbar at which the continuous paper web traveling roughly horizontally changes its direction of travel by 90° while being turned over to like-wise travel roughly horizontally. Above the path of travel of the continuous paper web running towards the turnbar there are arranged the inkjet printers regularly spaced in the direction of travel to print on one side surface of the continuous paper web. And, above the path of travel of the continuous paper web past the turnbar means there are arranged the inkjet printers regularly spaced in the direction of travel to print on the other side surface of the continuous paper web.

Thus, the continuous paper web is driven to run along its path of travel towards the turnbar to print on its one side surface and then is reversed at the turnbar, and the continuous paper web past the turnbar in the state that it is turned over is drive to run along its path of travel to print on its other side surface.

On the other hand, as described in JP 2003-11452 referred to above, the present technique assuming that the inkjet printing heads for printing a continuous paper web have their ink discharge ports directed downwards makes it necessary that the continuous paper web to be printed be guided below the inkjet printing heads while a side surface thereof to be printed is faced upwards.

Apropos, the known techniques described in the foregoing have had problems as mentioned blow.

To wit, the continuous paper web duplex inkjet printing units described in JP H11-320923 A and JP 2001-58446 A above require that the inkjet printers in one group to print on the one side surface and the inkjet printers in another group to print on the other side surface be arranged so as to be substantially coplanar and to be in a row in one direction and so that they in each group are regularly spaced apart from each other. As a result, it is required that the unit should become long in their arrangement direction and have an elongated planar area for its installation.

Also, while such a continuous paper web duplex inkjet printing unit is customarily equipped at its upstream side with a continuous paper web supply unit and at the downstream side with a processing unit for suitably processing the continuous paper web after printing to serve as a continuous paper web duplex inkjet printing system for consistently performing the printing and processing after printing, such a continuous paper web duplex inkjet printing unit requires the entire system to be elongated and it cannot help a single operator having some shortage of watch over monitoring operations of the entire printing system.

Also, in the continuous paper web duplex inkjet printing units described in JP 2003-11452 A above, a group of the inkjet printers to print on the one side surface in one row and a group of the inkjet printers in another row to print on the other side surface be arranged so that the two rows are perpendicular to (at 90° with) each other and substantially coplanar and that the inkjet printers in each group or row are regularly spaced apart from each other. Between the groups of inkjet printers there is disposed a turnbar inclined at 45° in orientation to the row of inkjet printers to print on the one side surface. Thus, the continuous paper web running roughly horizontally to pass by the inkjet printers to print on the one side surface and thereby printed on the one side surface is turned over around the turnbar by 180° while changing its direction of travel by 90° and then is led to the inkjet printers to print on the other side surface and thereby printed on the other side surface.

This duplex inkjet printing unit is consequently shorter in length in one direction than, but not much different in total length from, the continuous paper web duplex inkjet printing units described in JP H11-320923 A and JP 2001-58446 A above. In addition, since the inkjet printers to print on the one side surface and the inkjet printers to print on the other side surface are different in their arrangement direction by 90°, it requires somewhat larger rectangular planar area for installation, square with lengths in their respective arrangement directions as two adjacent sides, than that of the continuous paper web duplex inkjet printing units described in JP H11-320923 A and JP 2001-58446 A above.

Also, while this continuous paper web duplex inkjet printing unit as is the case with the continuous paper web duplex inkjet printing unit described in JP H11-320923 A and JP 2001-58446 A above is customarily equipped at its upstream side with a continuous paper web supply unit and at the downstream side with a processing unit for suitably processing the continuous paper web after printing to serve as a continuous paper web duplex inkjet printing system for consistently performing the printing and processing after printing, such a continuous paper web duplex inkjet printing unit must become larger in square planar area for installing the entire system must become elongated and it cannot help a single operator having some shortage of watch over monitoring operations of the entire printing system.

### DISCLOSURE OF THE INVENTION

It is an object of the present invention to reduce the planar area of installation for a duplex inkjet printing unit having a group of inkjet printers to print on one side surface and a group of inkjet printers to print on the other side surface. And, it is an object of the present invention to provide a continuous paper web duplex inkjet printing unit provided at its upstream side with a continuous paper web supply unit and at its downstream side with a processing unit for processing the continuous paper web after printing to serve as a continuous paper web duplex inkjet printing system for consistently performing the printing and processing after printing whereby the system can be made to be compact and a single operator is sufficient to operate and monitor the system as a whole.

In order to achieve the objects mentioned above, there is provided in accordance with the present invention in a first form of implementation thereof a continuous paper web duplex inkjet printing unit for inkjet printing on both sides of a continuous paper web with an inkjet printing head in an inkjet printer, which is configured to comprise a plurality of inkjet printers disposed so that they lie vertically in steps and their inkjet printing heads face downwards, and a paper threading path disposed below such an inkjet printer or printers in each steps for permitting the continuous paper web to be passed zigzag from an upper to a lower step successively.

And, in a second form of implementation of the present invention, a continuous paper web duplex inkjet printing unit is provided that is configured to further comprise dryer means disposed adjacent to the paper threading path between successive steps of such inkjet printers and adjacent to the paper threading path downstream of the inkjet printer in the first form of implementation.

Also, in a third form of implementation of the present invention, a continuous paper web duplex inkjet printing unit is provided that is configured to comprise two or more inkjet printers in each step in the first or second form of implementation.

According to the first form of implementation of the present invention, configuring a continuous paper web duplex inkjet printing unit such that a plurality of inkjet printers are disposed vertically in steps and so that their inkjet printing heads face downwards allows the planar area of installation for the continuous paper web duplex inkjet printing unit to be reduced to about ½ or less of the conventional continuous paper web duplex inkjet printing unit.

Also, providing a paper threading path disposed below such an inkjet printer or printers in each step for permitting the continuous paper web to be passed zigzag from an upper to a lower step successively allows a continuous paper web to be passed through the paper threading path, thereby permitting the continuous paper web to be printed on its obverse and reverse side surfaces alternately with inkjet printing heads in inkjet printers and those in successive steps.

Also, providing a paper threading path disposed below such an inkjet printer or printers in each step for permitting the continuous paper web to be passed zigzag from an upper to a lower step successively as mentioned above allows a continuous paper web of which a first (obverse) side surface is printed in an upper step to be guided with rollers which contact a second (reverse) side surface as the reverse of the obverse side surface and then to pass below an inkjet printing head in a lower step with the second side surface facing upwards, thereby permitting the second side surface to be printed with the inkjet printing head in the lower step without deteriorating the quality of the first side surface just printed such as by rubbing of printed images thereon.

Moreover, when the continuous paper web is guided into a space below an inkjet printing head in a further lower step, it can be guided with rollers which contact the first side surface with printing inks substantially dried and stabilized by the time the second paper side has been finished in printing, so that even if images printed on the first side surface are rubbed by rollers contacting this side surface, they are little deteriorated in quality by such rubbing or the like. It is of course that images just printed on the second side surface are also little deteriorated in quality such as by rubbing, so that printing with the further lower step inkjet printers can be effected on the first side surface. In the following, the same actions allow the second and first side surfaces to be alternately printed successively by steps having inkjet printers as many as they are piled. Printed matter of good quality is therefore obtained.

According to the second form of implementation of the present invention, not only are effects of the abovementioned first form of implementation had, but also the inks after printing can be better dried and made more stable than in the first form of implementation by the dryer means provided for the continuous paper web printed with upper step inkjet printer heads on the way it is guided into a space below a lower step inkjet printing head, so that as mentioned above, when the continuous paper web is guided into a space below the lower step inkjet printing head to have both its first and second side surfaces printed, even if printed images are rubbed by its contact with rollers for this guidance, the possibility of quality deterioration by such rubbing or the like can be still further reduced.

According to the third form of implementation of the present invention, not only are effects of the abovementioned first and second forms of implementation had, but also the number of steps can be reduced in inverse relation to the number of inkjet printer arranged in each step by providing a plurality of inkjet printers in each step. As a result, the height of a continuous paper web duplex inkjet printing unit can be set to a lower level, thus making access by an operator easier to various places in the continuous paper web duplex inkjet printing unit.

### BRIEF DESCRIPTION OF THE DRAWINGS

In the Drawings:

FIG. 1 is a schematic diagram schematically illustrating the makeup of a continuous paper web duplex inkjet printing system having a continuous paper web duplex inkjet printing unit according to the present invention;

FIG. 2 is a schematic view taken along the line A-A in FIG. 1 as viewed in the direction of arrow, illustrating the continuous paper web duplex inkjet printing unit;

FIG. 3 is a schematic view taken along the line B-B in FIG. 2, illustrating an essential part of the unit;

FIG. 4 is a schematic diagram schematically illustrating the makeup of a continuous paper web duplex inkjet printing unit according to the present invention, which differs in form of implementation from the continuous paper web duplex inkjet printing unit shown in FIG. 1; and

FIG. 5 is a schematic diagram schematically illustrating the makeup of a continuous paper web duplex inkjet printing unit according to the present invention, which differs in form of implementation from the continuous paper web duplex inkjet printing units shown in FIGS. 1 and 4.

### BEST MODES FOR CARRYING OUT THE INVENTION

Mention is now made of forms of implementation of the present invention with reference to Drawing Figures.

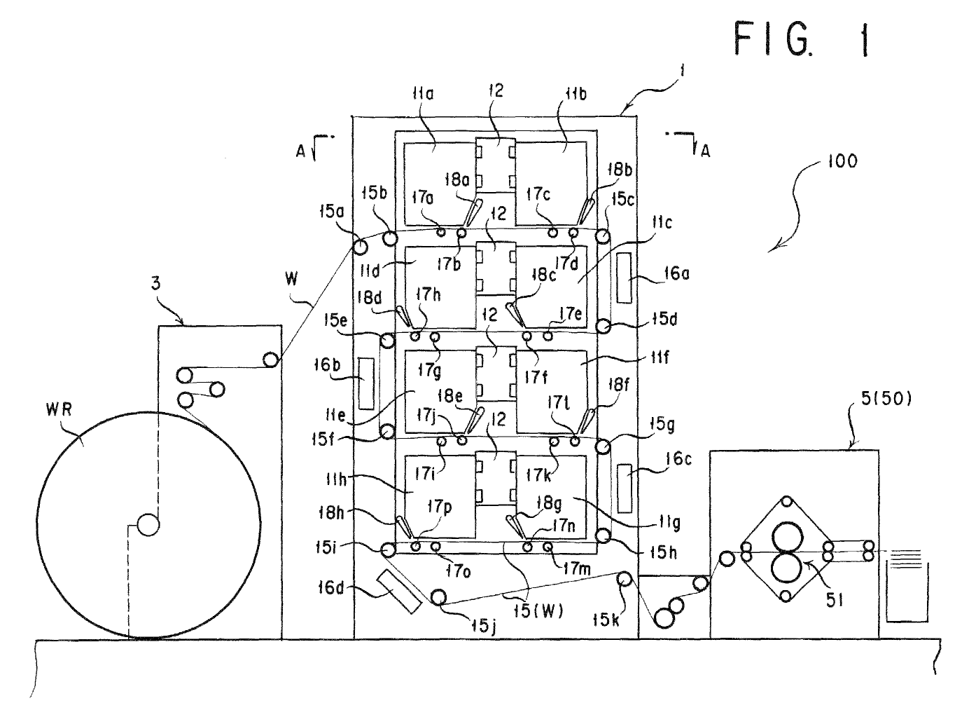

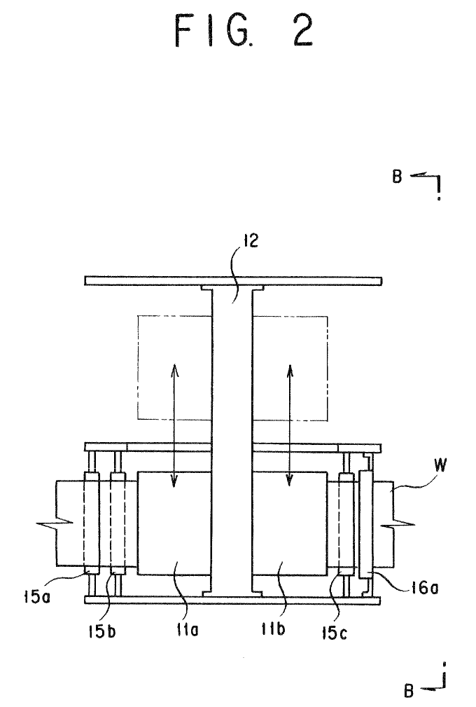

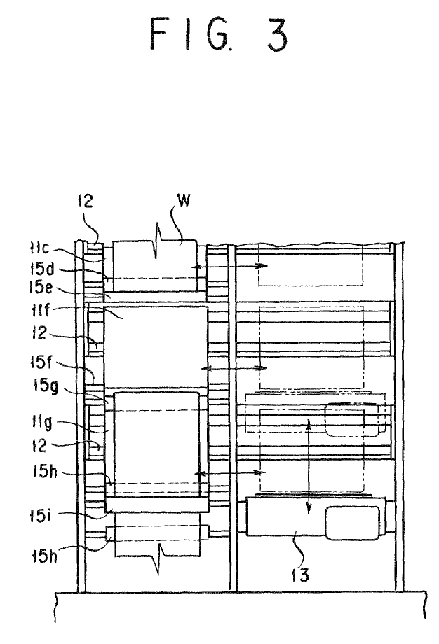

FIG. 1 is a schematic diagram schematically illustrating the makeup of a continuous paper web duplex inkjet printing system 100 having a continuous paper web duplex inkjet printing unit 1 according to the present invention. FIG. 2 is a schematic view taken along the line A-A in FIG. 1 as viewed in the direction of arrow, illustrating the continuous paper web duplex inkjet printing unit 1. FIG. 3 is a schematic view taken along the line B-B in FIG. 2, illustrating an essential part of the unit.

The continuous paper web duplex inkjet printing system 100 shown in FIG. 1 is provided at the upstream side of the continuous paper web duplex inkjet printing unit I with a continuous paper web supply unit 3 adapted to supply a continuous paper web W to the continuous paper web duplex inkjet printing unit 1 and is provided at the downstream side of the continuous paper web duplex inkjet printing unit 1 with a processing unit 5 constituted by a cutting unit 50 that is adapted to cut e. g., into a preset size the continuous paper web W printed by the continuous paper web duplex inkjet printing unit 1.

The continuous paper web duplex inkjet printing unit 1 is configured to comprise a plurality of inkjet printers 11a to 11h, each having an inkjet printing head (not shown) provided with an ink discharge port over a predetermined width, which are disposed vertically in four steps and by two each step.

The inkjet printers 11a to 11h have their respective inkjet printing heads' ink discharge ports facing downwards and are disposed so that at their respective printing positions their widthwise centers lie substantially coplanar. And, they are disposed so as to be movable by lateral moving means 12 equipped with, e. g., a feed screw mechanism (not shown) slightly for lateral registration of printing images, and largely between the printing positions and their maintenance positions (shown in alternate long and two short dashes lines in FIGS. 2 and 3) at which a maintenance operation is to be performed by maintenance means 13 on the inkjet printing heads after printing.

Also, the continuous paper web duplex inkjet printing unit 1 is provided below the respective inkjet printers 11a to 11h, namely below their respective inkjet printing heads in the steps with a plurality of guide rollers 15a to 15k which forms a paper threading path 15 such that the continuous paper web W can be passed zigzag in succession from an upper to a lower step. And, dryer means 16a to 16d are provided at positions where they are opposed to portions of the paper threading path 15 past a space below the inkjet printing heads in one step to a space below the inkjet printing heads in the next step, namely between the successive steps, and past a space below the inkjet printing heads in the lowermost step, respectively. In FIG. 1 there are also shown backup rollers 17a to 17p and suction means 18a to 18h for collecting ink mist emitted in printing.

According to the makeup mentioned above, the continuous paper web W pulled out of a continuous paper web roll WR mounted in the continuous paper web supply unit 3 disposed upstream of the inkjet printing unit is passed through the paper threading path 15 formed by the guide rollers 16a to 15k and after then is led to the cutting unit 50. Paper passage through the paper threading path 15 is effected preferably on moving the ink jet printers 11a to 11h to the maintenance position by means of the lateral moving means 12.

The continuous paper web W threaded from the continuous paper web supply unit 3 through the continuous paper web duplex inkjet printing unit 1 into the cutting unit 50 is adjusted in tension from the beginning of a printing operation and guided by the guide rollers 15a, 15b and 15c so that in traveling below the inkjet printers 11a and 11b in the uppermost step (first step) roughly horizontally between their respective inkjet printing heads and the backup rollers 17a, 17b and 17c, 17d the continuous paper web has images of a first ink, e. g of yellow and images of a second ink, e. g., of cyan printed on its one side surface which is then upwardly facing by the inkjet printer 11a and the inkjet printer 11b, respectively.

The continuous paper web W that traveled below the inkjet printers 11a and 11b in the uppermost step is changed downward in traveling direction by the guide roller 15c at the outlet side of the uppermost step that contacts its other side surface as the reverse of the one side surface which has been printed by the inkjet printers 11a and 11b and is then changed in traveling direction by the guide roller 15d lying at the inlet side of the second step and likewise contacting the other side surface to travel in a direction as the reverse of the direction in which it traveled below the inkjet printers 11a and 11b in the uppermost step and at the same time the continuous paper web W is turned over. And, while the continuous paper web is traveling between the guide rollers 15c and 15d, its one side surface which has been printed by the inkjet printers 11a and 11b is opposed to the dryer means 16a so that the images printed by the inkjet printers 11a and 11b are thereby dried.

The continuous paper web W on which the images printed by the inkjet printers 11a and 11b have been dried and which was changed in its traveling direction and then turned over is guided by the guide rollers 15d and 15e to travel below the inkjet printers 11c and 11d in the second step roughly horizontally between their respective inkjet printing heads and the backup rollers 17e, 17f and 17g, 17h and to have images of the first ink, e. g. of yellow and images of the second ink, e. g., of cyan printed on its other side surface which is then upwardly facing by the inkjet printer 11c and the inkjet printer 11d, respectively.

And then, the continuous paper web W that traveled below the inkjet printers 11c and 11d in the second step is changed downward in traveling direction by the guide roller 11e at the outlet side of the second step that contacts its one side surface as the reverse of the other side surface which has been printed by the inkjet printers 11c and 11d and is then changed in traveling direction by the guide roller 15f lying at the inlet side of the third step and likewise contacting the one side surface to travel in a direction identical to the direction in which it traveled below the inkjet printers 11a and 11b in the uppermost step and at the same time the continuous paper web W is turned over again. And, while the continuous paper web is traveling between the guide rollers 15e and 15f, its other side surface which has been printed by the inkjet printers 11c and 11d is opposed to the dryer means 16b so that the images printed by the inkjet printers 11c and 11d in the second step are thereby dried While in guiding the continuous paper web W the guide rollers 15e and 15f contact with its one side surface, since images printed on the one side surface by the inkjet printers 11a and 11b in the first step have been dried by the dryer means 16a in the course from the first to the second step, their printing quality will in no way be affected by the contact of the guide roller 15e, 15f with the continuous paper web W.

The continuous paper web W changed in its traveling direction by the guide roller 15f at the inlet side of the third step and then turned over again is guide by the guide rollers 15f and 15g to travel below the inkjet printers 11e and 11f in the third step from top roughly horizontally between their respective inkjet printing heads and the backup rollers 17i, 17j and 17k, 17l and to have images of a third ink, e. g. of magenta and images of a fourth ink, e. g., of black printed on its one side surface which is then upwardly facing by the inkjet printer 11e and the inkjet printer 11f, respectively. This printing stage completes printing on the one side surface with the four inks.

The continuous paper web W having printing finished on the one side surface with the four inks is changed downward in traveling direction by the guide roller 15g at the outlet side of the third step that contacts its other side surface as the reverse of the one side surface which has been printed by the inkjet printers 11e and 11f and is then changed in traveling direction by the guide roller 15h lying at the inlet side of the fourth step and likewise contacting the other side surface to travel in a direction identical to the direction in which it traveled below the inkjet printers 11c and 11d in the second step from top and at the same time the continuous paper web W is turned over the third time. And, while the continuous paper web is traveling between the guide rollers 15g and 15h, its one side surface which has been printed by the inkjet printers 11e and 11f is opposed to the dryer means 16c so that the images printed by the inkjet printers 11and 11f are thereby dried. While in guiding the continuous paper web W the guide rollers 15g and 15h contact with its other side surface, since images printed on the other side surface by the inkjet printers 11c and 11d have been dried by the dryer means 16b in the course from the second to the third step, their printing quality will in no way be affected by the contact of the guide roller 15g, 15h with the continuous paper web W.

The continuous paper web W changed in its traveling direction by the guide roller 15h at the inlet side of the fourth step and then turned over the third time is guided by the guide rollers 15h and 15i to travel below the inkjet printers 11g and 11h in the lowermost (fourth) step roughly horizontally between their respective inkjet printing heads and the backup rollers 17m, 17n and 17o, 17p and to have images of the third ink, e. g. of magenta and images of the fourth ink, e. g., of black printed on its other side surface which is then upwardly facing by the inkjet printer 11g and the inkjet printer 11h, respectively. This printing stage completes printing on the other side surface with the four inks.

In the printing actions mentioned above, if printing images on each side surface with each ink are out of resister, they are registered. To wit, registration in the continuous direction of a continuous paper web W is effected by controlling the timing of ink discharge from the inkjet printing head in each inkjet printer 11a-11h. Registration in the widthwise direction of a continuous paper web is accomplished by slightly moving each inkjet printer 11a-11h by the lateral moving means 12. Furthermore, the ink mist produced from the ink discharged from the inkjet printing head and impinging on the continuous paper web W is collected by the suction means 18a-18h provided for each inkjet printer 11a-11h at the downstream side of the traveling continuous paper web W.

The continuous paper web W printed by the inkjet printer 11g and 11h in the lowermost step and having printing finished on the other side surface with the four inks, namely having printing finished on the both side surfaces with the four inks, is changed downward in traveling direction by the guide roller 15i at the outlet side of the fourth step that contacts its one side surface as the reverse of the other side surface which has been printed by the inkjet printers 11g and 11h and is then changed in traveling direction by the guide roller 15j lying within an inverting passage and likewise contacting the one side surface to travel in a direction identical to the direction in which it traveled below the inkjet printers 11a and 11b in the uppermost step and at the same time the continuous paper web W is turned over the fourth time. And, while the continuous paper web is traveling between the guide rollers 15i and 15j, its other side surface which has been printed by the inkjet printers 11g and 11h is opposed to the dryer means 16d provided at the downstream side of the inkjet printers 11g and 11h in the lowermost step so that the images printed by the inkjet printers 11g and 11h are thereby dried. While in guiding the continuous paper web W the guide rollers 15i and 11j contact with its one side surface, since images printed on the one side surface by the inkjet printers 11e and 11f have been dried by the dryer means 16c in the course from the third to the fourth step, their printing quality will in no way be affected by the contact of the guide roller 15i, 15j with the continuous paper web W.

The continuous paper web W changed in its traveling direction by the guide roller 15j within the inverting passage and then turned over the fourth time is guided by the guide roller 15j and the guide roller 15k at the outlet side of the inverting passage to travel towards the processing unit 5 provided at the downstream side of the continuous paper web duplex inkjet printing unit 1. And, it is cut into sheets of paper by a cutting mechanism 51 in the cutting unit 50 as the processing unit 5.

After the printing operation mentioned above is ended, the inkjet printers 11a-11h, e. g., first the inkjet printers 11a and 11in the uppermost step, are moved laterally of their printing position by the lateral moving means 12 to their maintenance position as shown by alternate long and two short dashes lines in FIGS. 2 and 3 where their maintenance operations such as cleaning for their inkjet printing heads, are performed thereon by the maintenance means 13 so that problems do not rise in the subsequent printing operation.

The maintenance means 13 stands by at a standby position below the maintenance position, i. e. lower than discharge ports of inkjet printing heads of the inkjet printers 11g and 11h in the lower most step and is configured to be movable vertically along a frame so that it can be moved to the position at which to and does, perform the maintenance operation on the inkjet printers 11a-11h in each step.

After the maintenance operation on the inkjet printer 11a and 11b in the uppermost step is ended, a maintenance operation is performed on the inkjet printers 11c and 11d in the second step from top, followed by that on the inkjet printers 11e and 11f in the third step from top and that on the inkjet printers 11g and 11h in the lowermost step, each in the same manner as that mentioned above. When each of these successive maintenance operations is performed, first the maintenance means 13 is moved to the position at which the maintenance operation for the inkjet printers in the step to be maintained can be performed and then the inkjet printers in that step are moved by the lateral moving means 12 to the maintenance position shown by the alternate long and short dashes lines in FIGS. 2 and 3. The inkjet printers 11a-11in each step on which the maintenance operation has been performed is returned at a suitable timing to their printing position.

These maintenance operations may be performed on from the inkjet printers in the lowermost step to the inkjet printers in successive upper steps.

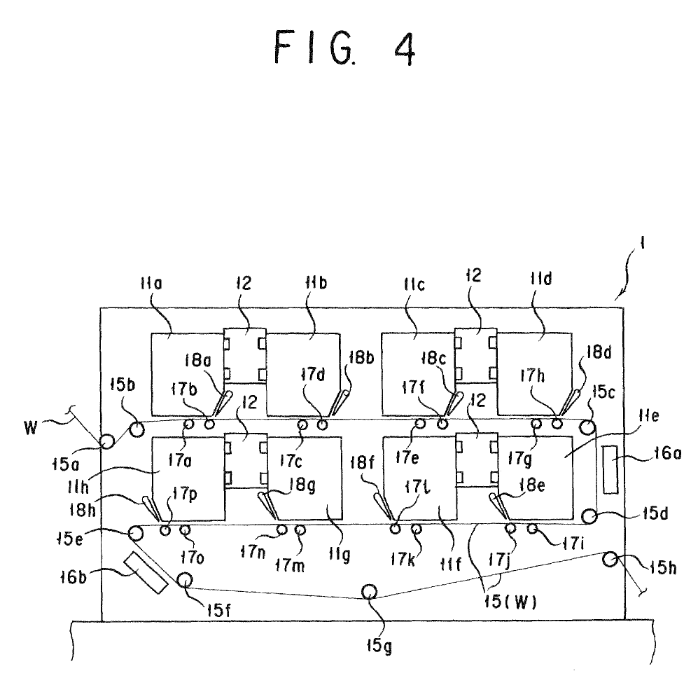

Note here that in the makeup of the continuous paper web duplex inkjet printing unit 1, the arrangement of a plurality of inkjet printers 11a-11h are not limited to that as shown in which they are arranged in vertically four steps with two in each step, and they may be arranged in vertically two steps with four in each step as shown in FIG. 4 or in vertically three steps with two, four and two sequentially from the top.

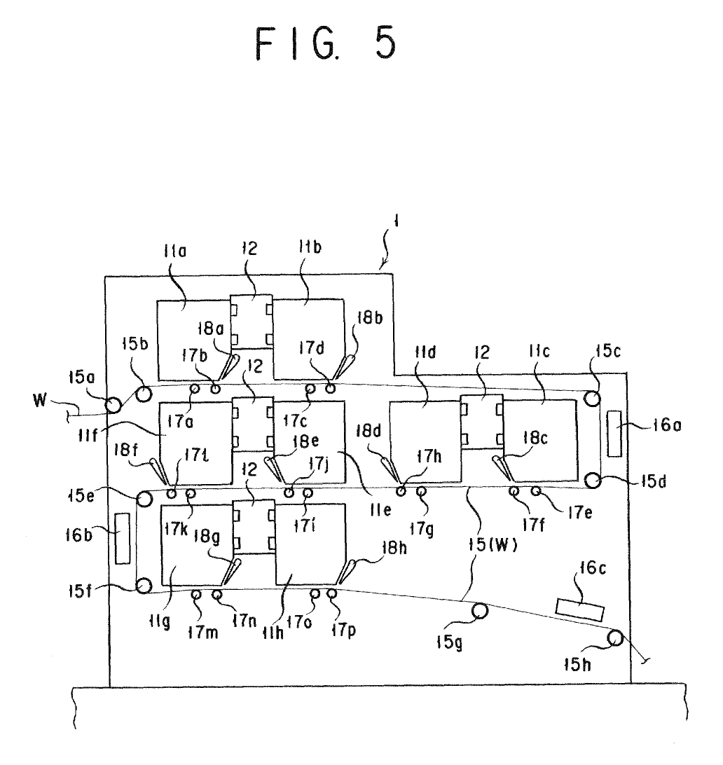

To wit, arranging the inkjet printers 11a-11h in an odd number of steps as shown in FIG. 5 eliminates the need to invert a continuous paper web W which has completed printing on both sides, making it possible to guide the continuous paper web W as it is to the processing unit 5 and to adjust its tension the easier. Also, according to the arrangement of the inkjet printers 11a to 11h shown in FIG. 4, it can readily be seen as shown that a continuous paper web W is printed first on its one side surface by the inkjet printers 11a to 11d and then on its other side surface as its reverse side surface by the inkjet printers 11e to 11h. According to the arrangement of the inkjet printers 11a to 11h shown in FIG. 5, it can readily be seen as shown that a continuous paper web W is printed first by the inkjet printers 11a and 11b on its one side surface, then by the inkjet printers 11c to 11f on its other side surface as its reverse side surface and then by the inkjet printers 11g to 11h on the one side surface which has been printed by the inkjet printers 11a and 11b.

Also, the number and arrangement of the guide rollers 15a to 15k constituting the paper threading path 15 and the number and arrangement of the dryer means 16a to 16d are not limited to those shown in FIGS. 1, 4 and 5 and may be those if they are without departing from the scope of Claims. Further, at least each one guide roller of the respective sets of two guide rollers 15c and 15d, guide rollers 15e and 15f, guide rollers 15g and 15h and guide rollers 15i and 15j in FIG. 1, at least each one guide roller of the respective sets of two guide rollers 15c and 15d and guide rollers 15e and 15f in FIG. 4 and at least each one guide roller of the respective sets of two guide rollers 15c and 15d, guide rollers 15e and 15f and guide rollers 15g and 15h in FIG. 5 may be constituted by rollers capable of heating the continuous paper web w, which may be provided to serve as both the guide rollers forming the paper threading path 15 and the dryer means 16. No special dryer means is necessary when ink is dried relatively quickly and each of those portions of the paper threading path 15 provided between the steps for the inkjet printers 11a to 11h and leading from the lowermost step to the cutting unit 50 has a length sufficient to allow the ink to dry in light of relationship with the speed of travel of the continuous paper web W.

Also, the lateral moving means 12 is not limited to the use of the feed screw mechanism and may use any other mechanism which enables a slight movement for lateral registration of printing images as well as a large movement between the printing position and the maintenance position (as shown by the alternate long and two short dashes lines in FIGS. 2 and 3) at which the maintenance operation is performed by the maintenance means 13 on the inkjet printing heads after printing. Further, while in the forms of implementation illustrated, one lateral moving means 12 is shown to move two of the inkjet printers 11a-11h, one such lateral moving means may, of course, be designed to move any one by one of the inkjet printers 11a-11h.

The present invention can be utilized as a printing machine for printing general prints such as leaflets, pamphlets and catalogues, or publications such as books and newspapers.

1. A continuous paper web duplex inkjet printing unit for inkjet printing on both sides of a continuous paper web with an inkjet printing head in an inkjet printer, characterized in that it comprises:
a plurality of inkjet printers disposed so that they lie vertically in steps and their inkjet printing heads face downwards; and
a paper threading path disposed below such an inkjet printer or printers in each step for permitting the continuous paper web to be passed zigzag from an upper to a lower step successively.

2. A continuous paper web duplex inkjet printing unit as set forth in claim 1, characterized in that it further comprises dryer means disposed adjacent to the paper threading path between successive steps of such inkjet printers and adjacent to the paper threading path downstream of the inkjet printer in the lowermost step.

3. A continuous paper web duplex inkjet printing unit as set forth in claim 1, characterized in that two or more inkjet printers are disposed in each step.

4. A continuous paper web duplex inkjet printing unit as set forth in claim 2, characterized in that two or more inkjet printers are disposed in each step.
